(19) United States
(12) Patent Application Publication
(10) Pub. No.: US 2006/0053012 A1
(43) Pub. Date: Mar. 9, 2006

(54) Speech mapping system and method

(76) Inventor: David John Eayrs, Charlottetown (CA)

Correspondence Address: SUGHRUE MION, PLLC, 2100 PENNSYLVANIA AVENUE, N.W., SUITE 800, WASHINGTON, DC, 20037, US

(21) Appl. No.: 11/165,019

(22) Filed: Jun. 24, 2005

Related U.S. Application Data
(60) Provisional application No. 60/606,892, filed on Sep. 3, 2004.

(51) Int. Cl. G10L 15/04

(52) U.S. Cl. 704/251

(57) ABSTRACT

A speech mapping system and method for assisting a user in the learning of a second language, comprising an extractor for extracting a first set of acoustic data from a monitored speech; said first set of acoustic data comprising aspiration, voicing, allophone/diphong timing and amplitude of the monitored speech; and a displayor to graphically display to said user said first set of acoustic data against a second set of acoustic data of a baseline speech.

### FIELD OF THE INVENTION

The present invention relates generally to a speech mapping system, and more particularly to a speech mapping system that is used as a language training aid that compares a user's speech with pre-recorded baseline speech and displays the result on a displaying device.

### DISCUSSION OF THE PRIOR ART

In recent years many attempts have been made to apply speech recognition and mapping systems to learning of foreign languages. These systems often perform speech recognition with reference to a pre-recorded model with which a user's utterance is to be compared. The user's attempt is often accepted or rejected, and rated, based upon an overall comparison of the user's speech, and based upon a predefined level of accuracy. Accordingly, the rating is the same for the entire speech, and the user cannot know from this rating which parts of the speech were correctly or incorrectly pronounced.

United States Patent Application No. 2002/1160341 (Yamada, Reiko et al) addresses this problem by providing an apparatus that separates the sentence into word speech information. Speech characteristics are extracted from each word, then compared with a previously stored model word characteristic. Results of evaluation are displayed for each word. Although the Yamada system divides the sentence into word speech information, it still uses a maximum likelihood comparison inside the word, which can comprise many syllables. Additionally, the system is only suitable for a user learning a language that is not phonologically distinct from his native language i.e. English to Latin, French to English etc. but not Hindi to English, or English to Arabic.

U.S. Pat. Nos. 5,791,904 and 5,679,001 (Russel et al.) describe training aids that provide an indication of the accuracy of pronunciation for the word spoken and display the characteristics of the user's speech graphically using the horizontal axis (X) to represent time, the vertical axis (Y) to represent frequency, while the intensity of the voice (volume) is represented by a degree of darkness of the graph. The Russel aids do not allow for a repetition of a certain syllable. They use a pass/fail test that does not provide opportunity to learn by repeating. Additionally, the manner of displaying the volume with degrees of darkness does not display accurately the intensity of the voice.

Other attempts have been also made to introduce facial displays to the training aids previously described that illustrate gestures on a face pronouncing the same words. For instance, U.S. Pat. No. 4,460,342 (Mills) describes a device for speech therapy. The device comprises a chart with a series of time frames in equal time intervals. Each of the time frames has an illustration of the human mouth that displays the lips, tongue and jaw positions used when generating a sound. However, this device displays the lip and tongue two-dimensionally, and excludes other elements of the face which have other necessary speech mechanics.

Additionally, most speech recognition systems try to interpret a user's speech as a native speaker. They may also assume that the amount of cultural data provided to the users in the volume and speech duration is sufficient for language acquisition. However, this is not the case when a user attempts to learn a language from a different culture. Furthermore, new speech users have patterns of speech and linguistic culture that hinder a speech recognition system from being effective. For instance, utterances, pauses, and lack of familiarity with the speech tool each allow extraneous speech data to be considered as the attempted speech provided by the user. Accent also plays an important role in language acquisition, and may skew the feedback provided to the user, thereby complicating the learning process. Accordingly these systems could be improved upon when learning a new language.

U.S. Pat. No. 5,870,709 (Bernstein) describes a method and apparatus for instructing and evaluating the proficiency of human users in skills that can be exhibited through speaking. The apparatus tracks linguistic, indexical and paralinguistic characteristics of the spoken input of a user, measures the response latency and speaking rate, and identifies the gender and native language. The extracted linguistic and extra-linguistic information is combined in order to differentially select subsequent computer output for the purpose of amusement, instruction, or evaluation of that person by means of computer-human interaction.

However, the Bernstein's apparatus estimates the user's native language, fluency, native language, speech rate, gender and other parameters from the user's speech without initially knowing his cultural background. For instance, a wrong pronunciation with a native accent ca lead the system to judge as right what the user has wrongly pronounced or the opposite. As well the system does not always detect the gender of a human from his speech accurate due to a plurality of parameters such hormones, age, culture, native country etc. Therefore, the precision of this system is a point of doubt which affects the precision of the following procedures in speech recognition. Therefore when these parameters are detected from the user's speech rather than being used as inputs by the user in order to perform speech recognition, the precision and accuracy of the system will be dramatically affected.

Additionally, the method of extracting the speech latency from a speech set and using this in the next speech set also affects the accuracy of the system as the latency may change between a speech set and another. Furthermore, if the speech latency is measured more than once during the learning session, the processor speed will be affected as more repetitive processing is required during speech detection. Moreover, this document does not describe a three dimensional graphical display in order to convey a multivariate speech. Graphical displays known in the art at the time of filing this application, used bivariate data resulting in the familiar oscilloscope style (wave) representation of the tone.

### SUMMARY OF THE INVENTION

In light of the above discussion, one object of the present invention is to provide an apparatus and method that facilitate ease of access during the language acquisition process. There is provided a speech mapping system for assisting a user in the earning of a second language, comprising an extractor for extracting a first set of acoustic data from a monitored speech; said first set of acoustic data comprising aspiration, voicing, allophone/diphong timing and amplitude of the monitored speech; and a displayor to graphically display to said user said first set of acoustic data against a second set of acoustic data of a baseline speech.

There is provided a speech mapping system where the extractor can divide first set of speech into phonemes, extract speech characteristics therefrom, and the displayor can display the speech characteristics three dimensionally in contrast with the second set, thereby permitting a user to detect, compare and repeat a mismatched sylable, word or sentence.

There is provided a speech mapping system where the displayor can illustrate major speech mechanics by displaying three dimensionally a head of a virtual teacher speaking the same words as those pronounced by the user.

There is provided a speech mapping system where the displayor can illustrate major speech mechanics by displaying three dimensionally a head of a virtual teacher speaking the same words as those pronounced by the user and the head can rotate in all directions to clearly illustrate the profile of the virtual teacher during pronunciation.

There is provided a speech mapping system where the displayor can illustrate major speech mechanics by displaying three dimensionally a head of a virtual teacher speaking the same words as those pronounced by the user and the head can have the face or gender of a typical resident of the native country or area of the user.

There is provided a speech mapping method for assisting a user in the earning of a second language, comprising an extracting step for extracting a first set of acoustic data from a monitored speech; said first set of acoustic data comprising aspiration, voicing, allophone/diphong timing and amplitude of the monitored speech; and a displaying step to graphically display to said user said first set of acoustic data against a second set of acoustic data of a baseline speech.

### BRIEF DESCRIPTION OF THE DRAWINGS

FIG. 1 is a block diagram of one configuration of the invention.

### DETAILED DESCRIPTION

The method and system of the present invention take into consideration the cultural and regional backgrounds of the user when determining the data requirements that he requires for acquisition of language and/or cultural information. The invention tracks the changes used to render interdependent variables onto a sound.

Acoustic and physical elements of speech such as synthesized vowel sounds and other information are represented as data and displayed as multi-dimensional graphics. Visualization of the relevant parts of speech can be provided with toot such as the robust 3-D graphical displays common to dedicated video gaming platforms and fifth generation video cards for personal computers. These displays are more relevant to the user than the familiar oscilloscope-style “wave” representation of tone used for wave files with bi-variate data results. Although such wave file representations show visual change in amplitude, multi-variate speech is not adequately displayed by graphing amplitude alone in this format.

Relevant variables are identified in order to display multi-variate speech. Example variables can include features of speech such as volume, pitch (frequency), change in frequency, “amount” and duration of fricative, “amount” and duration of plosive, time and duration of speech stops, voicing, point of articulation, articulation speed, deviation from typical vowel sounds, phonetic mapping, speech intonation, aspiration, and alophones/diphongs timing.

Each of the features of speech is associated with a scale that can be pre-determined (such as time and frequency) or constructed (such as with plosives and fricatives). Each feature can be used to visually represent the graphical representation of the speech sample.

The features of speech are displayed in a multi-dimensional image. This image can be based on a three-dimensional shape, with additional dimensionality being represented as deformation of the shape, colour of the shape, particle effects within the shape, opacity of the shape, etc. Individual parts of speech for an L1 language can be assigned a component of the graph. For example, the visualization of speech can place time on the z-axis as the primary axis of the display, with other properties displayed that change with respect to time. For example, frequency and amplitude can be placed on the x and y axes, thereby displaying current and average frequencies for the speech sample. A wave appearance can be provided to show changes in intonation of the speakers voice. Fricatives can be represented as a density of particles within the shape (representing the “hissing” or “spitting” action of a fricative). The point of articulation can be represented by the colour of the object. This renders vocalzations in a universally recognizable format.

In another example, the x-axis can represent the duration of the phrase or sentence, the y-axis is the amplitude or volume, and the z-axis represents the user aspiration. Computer graphic particle effects and the use of spectrum color and texture with the speech map can further graphically enhance particular allophones/diphongs. Tone can be reflected in the larger array of function curve slope values.

The representation of synthesized vowel sounds and other information can be displayed across differing dialects, accents, usages and vocalization within a population. Representation and display of inter-cultural vocalization can also be provided.

The representation of information is provided from the speech mapping of speech input data using Markov hidden model, Fourier series, inverse Fourier transform, or other mapping and modelling tools that can be adapted to acoustic harvesting. The mapping can take into consideration the accent, language pattern, regional background, and linguistic culture of the user. For example, Markov data can be displayed graphically in pie charts that incorporate fuzzy logic to determine the accuracy of the relevant phonems. The resulting graphs can then be used to display differences in inflection.

The mapping is programmed in a software application that provides at least one interface display such as a GUI window for graphical display of the SMP. The application can run on computer hardware such that controls such as play/pause, etc., are provided. The user can interact with the interface display for range selection.

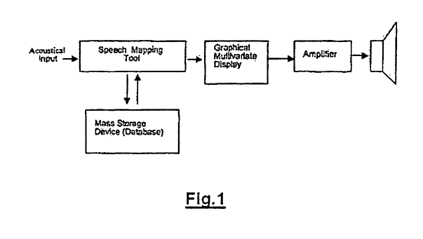

The displayed information is used to illustrate both acoustic input data and comparative baseline information received from a mass storage device. The speech mapping tool analyzes the data and outputs into a graphical multi-variate display. An amplifier can provide audible information to the user as well, as is shown in FIG. 1.

The speech mapping system works by having all the variable data specified L2 speech organized in such a way that the L2 language of another L2 speaker's speech map will then be analyzed. A statistical comparison between the recorded and the baseline L2 speech illustrates the differences in features such as aspiration, voicing, timing, amplitude by graphically superimposing the two images.

Through this graphical comparison the user can see as well as hear the differences in his/her speech to that of the baseline speech. Through the manipulation of his/her own voice the student can change the shape of his multi-variate graph to conform to the baseline L2 speech. The multidimensional graphic illustrates to the user by using statistical comparison, an evaluation of the variances in that person's speech against a baseline segment of the same speech. The user's ability to change his voice in voicing, aspiration duration, tone, amplitude and other features can be matched to the file of a virtual teacher. For example, ethno-culturally relevant linguistic components can provide the user with a variable tool.

One illustrative example follows. When first running the program, the user is required to define his profile. The user's profile may include the following: native language, language to be learned, gender, specifications of the virtual teacher, user name, password etc.

After determining his profile, the user is required to calibrate the acoustical input device to take into account and isolate the background noise. In this process, the system reviews statistical data in its database, then selects a suitable degree of tolerance or a tolerance pattern for the speech pattern, accents, or other characteristics inherent in the user's pronunciation. Inclusion of this tolerance minimizes the regional and cultural effects which are difficult for a user to isolate when learning a new language. It also helps separate the background noise from the input speech during analysis.

The user selects an acquisition process module from a menu. The acquisition process can be divided into, for example, three major modules: vocabulary/listening, pronunciation, and cultural elements.

1. Vocabulary/Listening:

In this module, the user begins with the most basic understanding of the desired language. The objective of this module is to introduce the user to the text, sound and meaning of relevant vocabulary words. No acoustical input is required from the user at this point. The user's ongoing and demonstrated mastery of these vocabulary words will enable him to combine them in phrases and/or sentences in further levels of the module. The system uses the native Language orientation to advance the language to be acquired.

2. Pronunciation:

In the major secondary module, the system records the user's speech via a calibrated input device. Characteristics recorded include the amplitude and deepness of the user's voice. A speech mapping engine is used to chart several elements of the speech, including the tone inside each word. The speech is then displayed in an interactive three dimensional multi-variate representation that allows the user to vocally participate in learning new ways of speaking the new language.

The system has the ability to identify points of speech that are outside of compliance. The user can then manipulate his voice in particular ways and practice the mismatched part until a compliance with the baseline speech occurs.

The interactive three dimensional multi-variate representation can be a graphical comparison using different colors and graphical representations to differentiate the user's speech from the baseline speech. The three-dimensional graphical representation includes time, frequency, and volume. Each of these parameters is represented on different axes in order to allow the user to adjust his speech latency and volume to comply with the baseline speech. This display allows the user to detect which parts of the speech were wrongly pronounced, which permits the user to repeat and try to improve in a specific pronunciation, until compliance with the baseline speech. Unlike traditional spectrograms that depict constrictions and extensions as light and dark regions on a cylinder, the multi-variate representation here can “bend” the cylinder to show the change in tone within a word or a phrase.

The system can also display the user's speech characteristics in the form of a simulated re-enactment by a three dimensional “talking head”. The head acts as a virtual teacher that displays the proper jaw positions required for correct pronunciation of a certain word, and can be rotated to present various views of the jaw position. The virtual teacher thus displays the desired spoken baseline level that is understood by most speakers of this language. This display can be provided in the form of a “layered head”, where the ethnicity of a typical speaker of the desired language is displayed by an appropriate face. The face is also three dimensionally displayed, and is rotatable in all directions to present both the face gestures and the jaw positions of the virtual teacher.

The virtual teacher then interacts with the user to assess and evaluate the speech recorded in relation to the baseline desired. The user participates in interactive video sessions where he interacts with the virtual teacher to determine whether the user's speech is “in complance”, “confusing”, or “wrong” in the context of question and answer sessions. The user's speech is considered “in compliance” if it meets the baseline requirements, taking into consideration accent, and regional and cultural backgrounds. The user's speech is considered “confusing” if the system interprets this as words found in the database but different than what the virtual teacher pronounced or somewhat unrelated to the subject. For example, if the virtual teacher asks “what do you like to drink?” and the user answers “pizza”. The speech is considered “wrong” when the user's answers are not found in the database, or found in the database but not related to the subject. For example, if the user answers the previous question with the word “car”, which is not related to any food or drink.

The virtual teacher could be bilingual, speaking both the native language of the user and the language to be acquired. In a different embodiment, the virtual teacher could have the same regional accent as the user, and/or the regional accent of a specified area speaking the language to be acquired (for example, the accent of a user from southern China and British English accent.).

3. Cultural

After the vocabulary/listening and the pronunciation modules have been mastered, the third of the acquisition process modules can be accessed to focus on cultural aspects of the language. The cultural elements module utilizes several factors and databases in order to teach aspects of the culture within which the desired language is spoken. In addition to the traditional dictionary system with its syntax, grammar, phonology, and morphology data, it can access additional information relevant to language acquisition, language immersion, and cultural immersion.

The user participates in interactive video sessions involving topics such as, for example, visiting a restaurant in China for a meal. Video sessions are engaged wherein scenes are illustrated from the user's frame of reference. The timing, nuance, and other factors provided by the user are assessed in the context of each scene, and the virtual teacher reacts with words and gestures that signal the appropriateness of this input.

It is understood that the system and method can use several types of databases. For example, where users are unable to access the internet, or users prefer using the program on a Playstation® or an XBOX®, a customized version of the program can be provided on a recording medium upon request. In this case, the user is required to specify the language to be learned and his profile along with the request, so that the service provider knows what portion of the database is to be included in the customized version.

In another example, users with access to the internet can access the database of the service provider online, thereby benefitting from a regular update of their programs and from access to learning another language without paying for an additional customized version of the software. In this case, the recording medium can include standard and basic versions of the program for configuring the computer, and the remaining data can be accessed via internet. The latter design is also efficient as a security key for preventing unauthorized access and illegal copying of the program, whereby the server of the service provider blocks any unauthorized user using an authorized user's recording medium from any location different than that of the authorized user.

The system can be configured to run automatically or by prompts. It can, for example, provide the option of saving a progress point for users who are not using the program for the first time, whereby the user can start from the point he reached in the previous exercise saving time by avoiding repetition of a step that the user has already mastered.

Other displays are also possible. For example, the system may also include a breath display that illustrates the quantity and manner in which air is expelled by the virtual teacher during pronunciation. In another embodiment the system may include a comparison between the breath display of the user and that of the virtual teacher which also helps the user adjusting his breath, and control his strength when pronouncing a certain word.

1. A speech mapping system for assisting a user in the learning of a second language, comprising
an extractor for extracting a first set of acoustic data from a monitored speech; said first set of acoustic data comprising aspiration, voicing, alophone/diphong timing and amplitude of the monitored speech; and
a displayor to graphically display to said user said first set of acoustic data against a second set of acoustic data of a baseline speech.

2. Claim 1 where the extractor can divide first set of speech into phonemes, extract speech characteristics therefrom, and the displayor can display the speech characteristics three dimensionally in contrast with the second set, thereby permitting a user to detect, compare and repeat a mismatched syllable, word or sentence.

3. Claim 1 where the displayor can illustrate major speech mechanics by displaying three dimensionally a layered head of a virtual teacher speaking the same words as those pronounced by the user.

4. Claim 3 where the layered head can rotate in all directions to clearly illustrate the profile of the virtual teacher during pronunciation.

5. Claim 3 where the layered head can have the face/or gender of a typical resident of the native country or area of the user.

6. A speech mapping method for assisting a user in the learning of a second language, comprising
an extracting step for extracting a first set of acoustic data from a monitored speech; said first set of acoustic data comprising aspiration, voicing, allophone/diphong timing and amplitude of the monitored speech; and
a displaying step to graphically display to said user said first set of acoustic data against a second set of acoustic data of a baseline speech.
